(19) United States
(12) Patent Application Publication
(10) Pub. No.: US 2025/0189817 A1
(43) Pub. Date: Jun. 12, 2025

(54) HINGE SYSTEM FOR SPECTACLES FRAME, AND SPECTACLES COMPRISING SUCH A HINGE SYSTEM

(71) Applicant: IDEATECHNIC S.A.R.L., Luxembourg (LU)

(72) Inventor: Serge LAFITTE, Luxembourg (LU)

(21) Appl. No.: 18/845,449

(22) PCT Filed: Mar. 10, 2023
(86) PCT No.: PCT/IB2023/000156

§ 371 Date: Sep. 10, 2024

(30) Foreign Application Priority Data
Mar. 10, 2022 (FR) FR2202107

(51) Int. Cl. G02C 5/22

(52) U.S. Cl. CPC G02C 5/22

(57) ABSTRACT

The invention relates to a hinge system (1) for eyewear, comprising:
a first element (10) with a retaining element (12);
a second element (20) with a hooking part (22) forming a hook (24), the hook (24) being configured to reversibly engage the retaining element (12), the hook (24) and the retaining element (12) being configured to allow, in an engaged configuration, the rotation of the first element (10) relative to the second element (20) between at least a first position and at least a second position, the second element (20) comprising an elastic return device (26) configured to:
when the first and second elements (10, 20) are in an engaged configuration, urge the retaining element (12) into a position where the retaining element (12) is held by the hook (24), so that the action of the elastic return device (26) opposes the release of the retaining element (12); and to
elastically deform to allow the engagement or disengagement of the retaining element (12) and the hook (24) when a sufficient force is applied to the elastic return device (26).

The invention relates to the field of eyewear and more specifically to a hinge system for an eyewear frame, as well as eyewear equipped with such a hinge system.

Eyewear available on the market typically includes a frame equipped with a lens or lenses, with the lens or lenses serving to correct vision and/or provide sun protection and/or physical protection for the wearer. An eyewear frame generally includes a front part designed to support the lens or lenses and two temples articulated on the front part, each temple being articulated by means of an articulation device such as a hinge.

The articulation device allows the corresponding temple to pivot relative to the front part, between a folded position, in which the temple is parallel or slightly inclined relative to the front part, and an unfolded position, in which the temple is substantially perpendicular to the front part. The folded position of the temples reduces the bulk of the eyewear when not worn, particularly to facilitate storage in a case or pouch. The unfolded position is used when the eyewear is worn by an individual.

Conventionally, an eyewear hinge includes a first part, attached to the front part (or a temple) and featuring two knuckles, and a second part, attached to a temple (or the front part) and featuring a knuckle inserted between the aforementioned two knuckles. A fixing screw passes through two of the knuckles and is screwed into the third knuckle. This fixing screw also serves as a pivot during the temple's pivoting movement relative to the front part, and it is known that regular use eventually leads to the loosening of the fixing screw, this loosening affecting the stability of the corresponding temple and often resulting in the loss of the screw. This type of classic eyelet hinge is described, for example, in patent documents KR101392195B1 and US2021/240007A1.

Generally, it is very difficult for an eyewear wearer to intervene on the fixing screw themselves, even just to tighten it, due to its very small size, which requires the use of a specialized tool. It is all the more difficult for the eyewear wearer because these operations require very good close-up vision, while at the same time, the wearer is deprived of the eyewear they wish to work on.

Furthermore, the very small size of the fixing screw greatly complicates maintenance and repair operations that require handling this screw. For example, the fixing screw may break, and the operations to extract and replace the broken screw are then very delicate, if not impossible, without damaging the hinge.

Moreover, the aforementioned fixing screws are generally made of metal, so they cannot be covered with acetate or other varnish. As a result, these screws, and particularly their heads, are highly visible, which detracts from the aesthetics of the eyewear.

The problems outlined above are even more significant in the case of hinges featuring a system that allows the temples to extend beyond the unfolded position, commonly referred to as ‘flex’ hinges. Indeed, such a system generally requires an additional component (such as a spring) attached to the hinge, which makes the assembly and disassembly of the hinges even more complex, even for a professional.

patent Flex hinge systems using springs are known from documents CN105759454A, WO2014/193202A1, and U.S. Pat. No. 3,145,254, but their particularly rudimentary design makes them fragile, unattractive, and bulky.

It appears, therefore, that the design of known eyewear frame hinges presents numerous drawbacks.

The present invention aims to address the disadvantages of the prior art, particularly those described above, by proposing a hinge system for eyewear frames that can be assembled and disassembled without screws, without tools, and in a simple and quick manner. Another objective of the invention is to propose a hinge system for eyewear frames that is robust and aesthetically pleasing.

To this end, the invention relates to a hinge system for eyewear, the hinge system comprising:
a first element featuring a retaining element;
a second element featuring a hooking part forming a hook, the hook being configured to reversibly engage the retaining element of the first element, the hook and the retaining element being configured to allow, in an engaged configuration of the first and second elements, the rotation of the first element relative to the second element between at least a first position, or folded position, and at least a second position, or unfolded position, the second element featuring an elastic return device, which is an angular action spring configured to:
when the first and second elements are in an engaged configuration, urge the retaining element towards a position where the retaining element is held by the hook, so that the action of the elastic return device opposes the release of the retaining element by the hook; and to
elastically deform to allow the engagement or disengagement of the retaining element and the hook when a force is applied to the elastic return device through the first element with sufficient intensity,
   and wherein the second element features an open cavity formed in the hooking part so that the hook defines part of the cavity, said cavity being configured to allow the insertion of the retaining element.

Moreover:
the elastic return device is positioned within the cavity, which features a support wall acting as a support for the elastic return device,
the elastic spring device has a part that urges the retaining element in the engaged configuration, with the support wall and said part forming a general ‘V’ shape.

Thus, the hinge system for eyewear according to the invention allows for the assembly and disassembly of eyewear temples without tools (notably due to the absence of fixing screws and/or threading), in a simple and quick manner, even ‘blindfolded’. This ‘flex’ hinge system also allows for much simpler and more compact assembly compared to the hinge systems of the prior art mentioned above. Moreover, the hinge is more robust and aesthetically pleasing since the spring is confined within the cavity and is not visible when mounted in said cavity.

The hinge system according to the invention is adaptable to all types of eyewear featuring articulated temples, regardless of the type of eyewear frame design (acetate frame, drilled or rimmed frame, ‘nylor’ type, etc.), eyewear shape, materials used, etc. Moreover, in an advantageous embodiment, the hinge system according to the invention allows for the simple creation, without additional cost and without extra components, of a ‘flex’ type hinge, enabling an additional extension beyond the unfolded position of the temples, with an elastic return.

Additionally, since the hinge system according to the invention does not include a visible axis or metal screw that needs to be unscrewed, the top and bottom of the temples can be covered with acetate or other varnish, unlike the aforementioned prior art systems, making each temple particularly aesthetic.

This hinge system also allows for a complete lateral accidental detachment of a temple without damage, which is impossible with a screw or Flex hinge from prior art, where the temple or the screw hinge inevitably ends up breaking or tearing off the frame irreparably.

In one embodiment, the elastic return device is further configured to elastically deform to allow a displacement of the retaining element relative to the hook when the first element is rotated from the unfolded position, in the same direction as the transition from the folded position to the unfolded position, with the cavity being configured so that the displacement of the retaining element allows for exceeding the unfolded position, the first element being returned to the unfolded position by the action of the elastic return device when no longer solicited.

In one embodiment, the cavity contains the entire elastic return device, which is laterally sealed by the side walls of the first element.

In one embodiment, the elastic return device includes at least one leaf spring or torsion spring.

In one embodiment, the elastic return device has a general ‘V’ shape, with the elastic return device comprising a first part and a second part, the two parts forming an angle between them when the elastic return device is not solicited, preferably an angle less than 90°.

In one embodiment, the first part and the second part have identical lengths.

In one embodiment, the elastic return device is a single-leaf spring with a flexible blade, one end of said blade being inserted into a groove formed in the support wall. The base of the blade end is wider than the rest of said blade, the groove having a shape complementary to said base, such as a dovetail joint. The support wall and the flexible blade define a general ‘V’ shape.

In one embodiment, the second element includes an open cavity formed in the hooking part so that the hook defines part of the cavity, the cavity being configured to allow the insertion of the retaining element.

In one embodiment, a free edge of the support wall located opposite the hook includes a lip to position and hold the elastic return device.

In one embodiment, the retaining element is integral with the first element or removably mounted on the first element.

In one embodiment, the retaining element has a straight cylindrical shape, particularly with a circular base.

In one embodiment, the first element includes two side walls shaped to partially enclose the second element, each side wall featuring a cavity configured to receive one end of the retaining element.

In one embodiment, the side walls are configured to enclose the second element in the engaged configuration.

In one embodiment, the retaining element includes at least a central part with a smaller cross-sectional area than the ends, the central part forming a bearing surface for the elastic return device, the retaining element being mounted for rotation within the first element.

In one embodiment, the central part of the retaining element features at least one flat surface.

In one embodiment, the retaining element has at least one flat surface forming a bearing surface for the elastic return device, the retaining element being rotationally fixed to the first element, the cooperation between the flat surface and the elastic return device allowing for indexing the first element in a determined angular position relative to the second element.

In one embodiment, the retaining element includes two flat surfaces with different orientations, providing two distinct indexed positions, corresponding, for example, respectively to the unfolded and folded positions. 30

In one embodiment, the second element includes two half-parts assembled along a plane perpendicular to the rotation axis of the first element.

In one embodiment, the second element includes an indexing element for the position of the elastic return device, such as a protruding element cooperating with a notch formed in the elastic return device.

In one embodiment, the first element includes a lever with one end integral with the retaining element, the lever including, at an end opposite the retaining element, a fixing part, the second element featuring a housing communicating with the cavity, the housing being configured to receive part of the lever and allow its rotation when the first and second elements are in the engaged configuration.

The invention also relates to eyewear featuring two temples connected to a front part, each temple being articulated by means of a hinge system as described above, with the unfolded and folded positions of each hinge system corresponding respectively to the unfolded and folded positions of the respective temple.

In one embodiment, each hinge system is configured to allow an extension movement, that is, a rotational movement of the corresponding temple, in the same direction as the rotation allowing the transition from the folded position to the unfolded position, bringing the temple beyond the unfolded position, the extension movement generating an elastic deformation of the elastic return device under the action of the retaining element.

In one embodiment, the retaining element moves, during the extension movement of the corresponding temple, along a bottom wall of the cavity, with the bottom wall preferably featuring a convex portion.

In one embodiment, the second element includes a rear part with a recess configured to guide an inner edge of the corresponding temple during the extension movement.

In one embodiment, the first element and/or the corresponding temple includes an inner edge with a protruding portion that cooperates with the recess of the second element during the extension movement.

In one embodiment, for each temple, the first element of the corresponding hinge system is integral with the front part, while the second element is integral with the temple.

In one embodiment, for each temple, the second element of the corresponding hinge system is integral with the temple, while the first element is integral with the front part.

In one embodiment, for each temple, the second element is configured such that the hook is positioned on the inner side of the temple. This configuration better preserves the physical integrity of the system, the temples, and the frame during a complete accidental lateral detachment of a temple, without damage.

In one embodiment, for each temple, the second element is configured such that the hook is positioned on the outer side of the temple.

This invention will be better understood upon reading the following detailed description, made with reference to the attached drawings, in which:

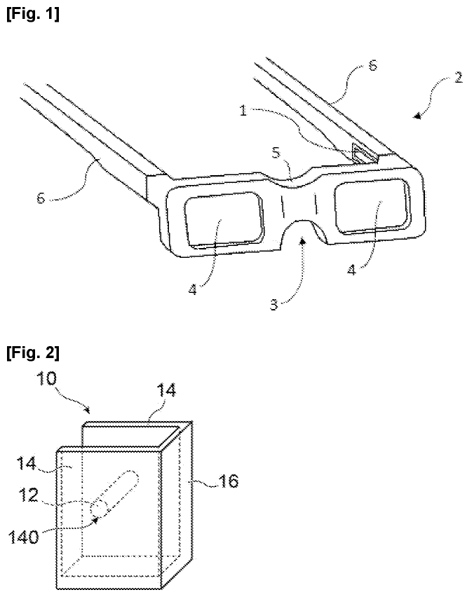

FIG. 1 is a perspective view of eyewear equipped with hinge systems according to the invention.

FIG. 2 is a perspective view of a first element of a hinge system according to the invention.

FIG. 3 is a perspective view of a second element of a hinge system according to the invention, shown without the elastic return device.

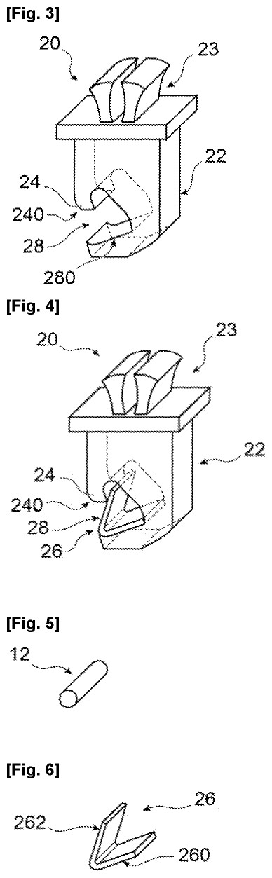

FIG. 4 is a perspective view of the second element equipped with the elastic return device.

FIG. 5 is a perspective view of the retaining element of the first element.

FIG. 6 is a perspective view of the elastic return device.

FIG. 7 is a perspective view of a hinge system according to the invention in which the first and second elements are assembled.

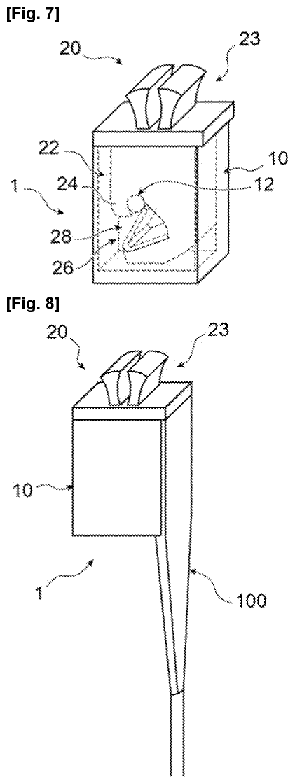

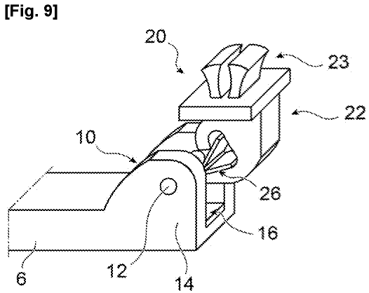

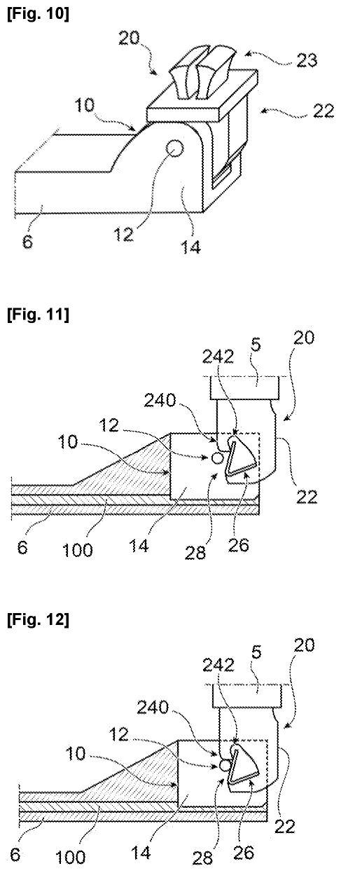

FIG. 8 is a perspective view of a hinge system according to the invention in which the first and second elements are assembled, with the first element being integral with a temple frame of eyewear.

FIG. 9 is a perspective view of a hinge system according to the invention, with the first and second elements being assembled, and the first element being formed directly in a temple of eyewear.

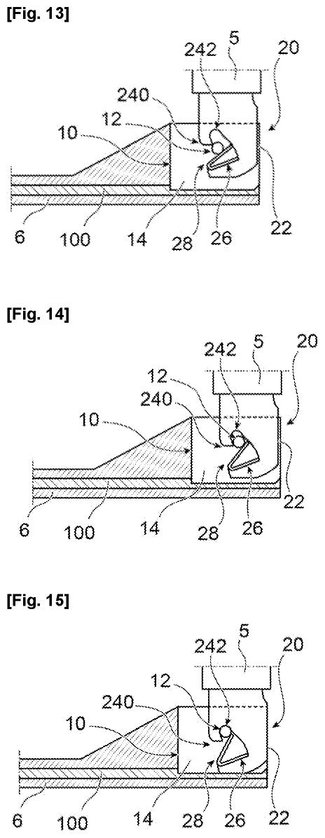

FIG. 10 is a view of the hinge system from FIG. 9, with the first and second elements assembled.

FIG. 11 illustrates an initial stage of assembling an eyewear temple according to the invention.

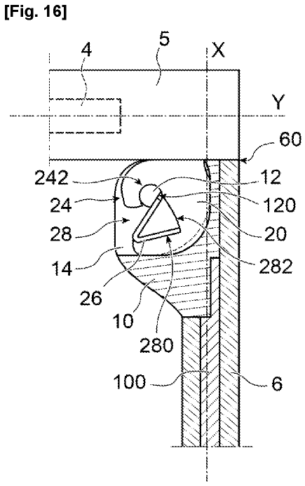

FIG. 12 illustrates a first intermediate stage of assembling an eyewear temple according to the invention.

FIG. 13 illustrates a second intermediate stage of assembling an eyewear temple according to the invention.

FIG. 14 illustrates a third intermediate stage of assembling an eyewear temple according to the invention.

FIG. 15 illustrates a final stage of assembling an eyewear temple according to the invention.

FIG. 16 shows a temple of the eyewear from FIG. 1 in an unfolded position.

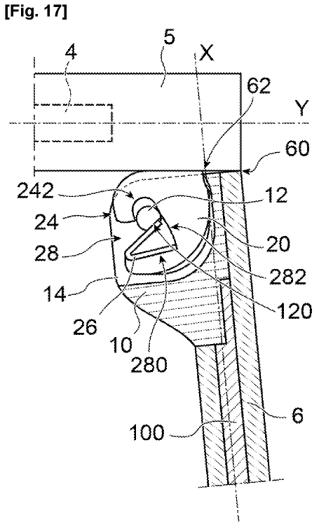

FIG. 17 is a view similar to FIG. 16, with the temple in a first extension position.

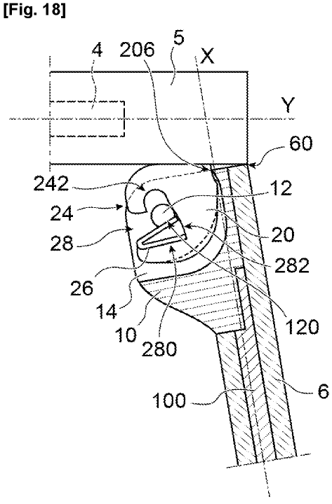

FIG. 18 is a view similar to FIG. 16, with the temple in a second extension position.

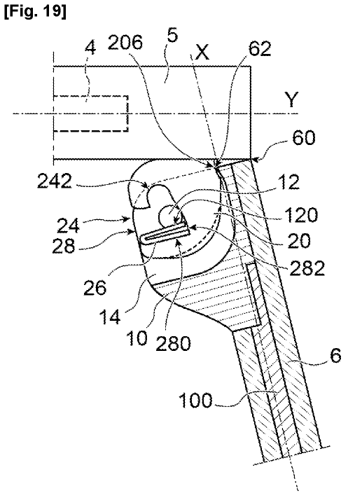

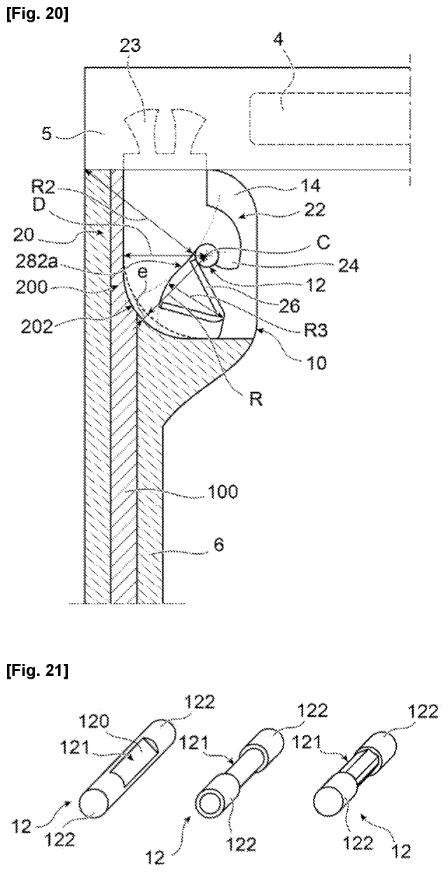

FIG. 19 is a view similar to FIG. 16, with the temple in a third extension position.

FIG. 20 illustrates an embodiment of the hinge system in which the second element is configured to allow the return of the first element to the unfolded or folded position, with the eyewear temple carrying the first element in an unfolded position.

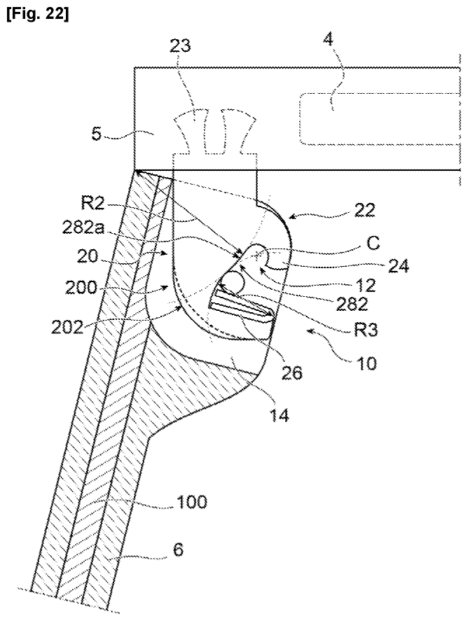

FIG. 21 is a perspective view showing different variants of the retaining element.

FIG. 22 illustrates an embodiment similar to that of FIG. 20, with the temple carrying the first element in an extension position.

FIG. 23 illustrates an embodiment of the hinge system in an unfolded position.

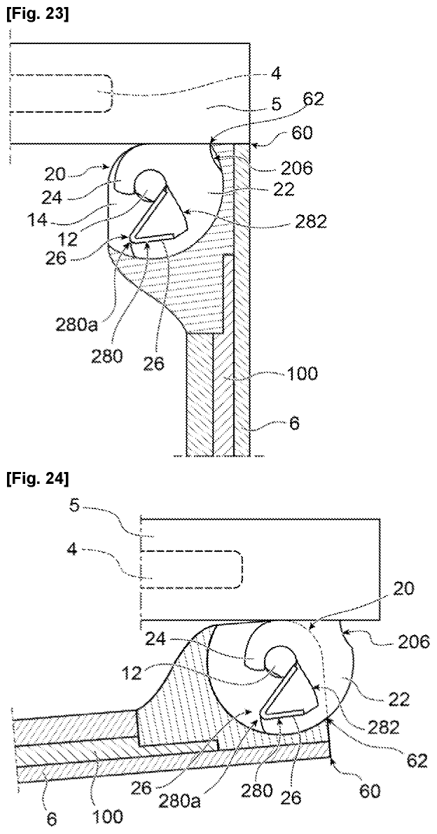

FIG. 24 illustrates an embodiment of the hinge system in a folded position.

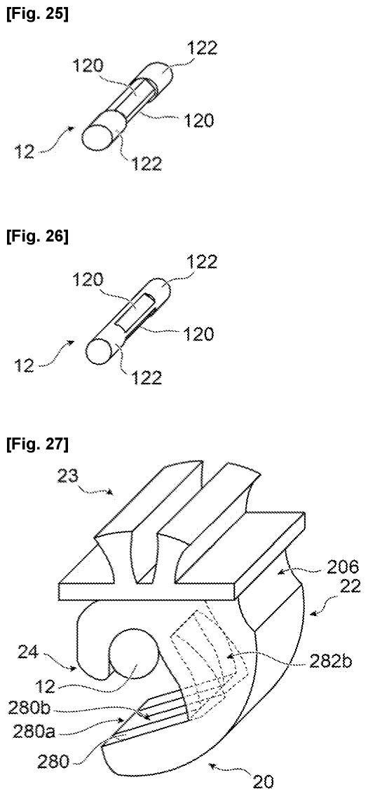

FIG. 25 is a perspective view of a retaining element.

FIG. 26 is a perspective view of a retaining element.

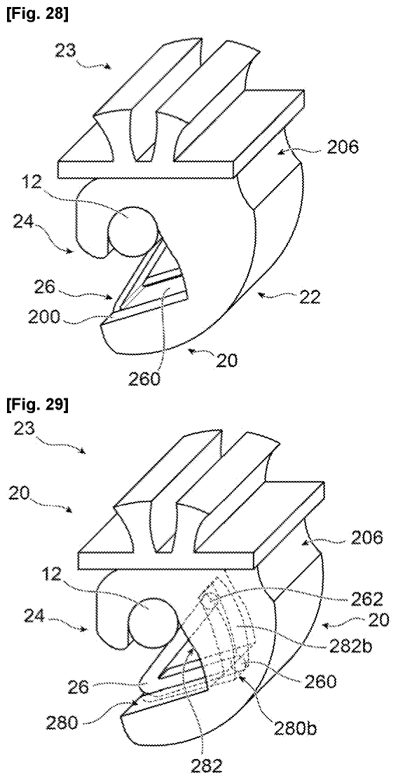

FIG. 27 is a view of an embodiment of the second element.

FIG. 28 is a view of the second element from FIG. 27.

FIG. 29 is a view of an embodiment of the second element.

FIG. 30 is a perspective view of an embodiment of the hinge system particularly suited for rimmed eyewear.

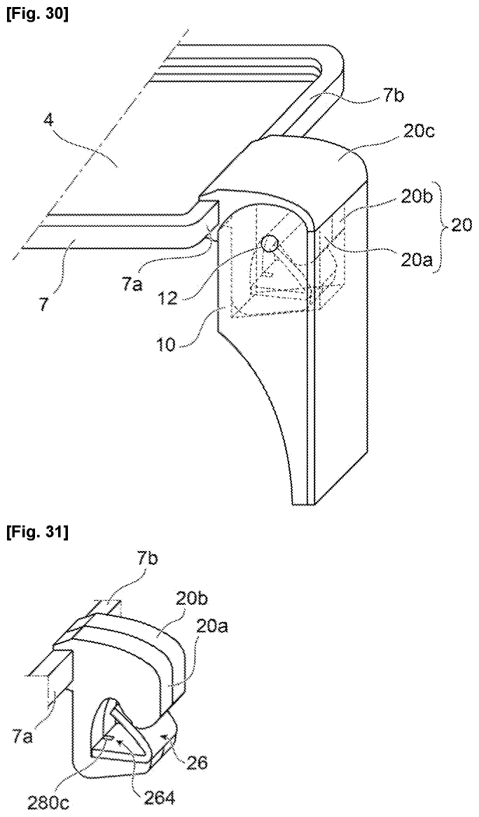

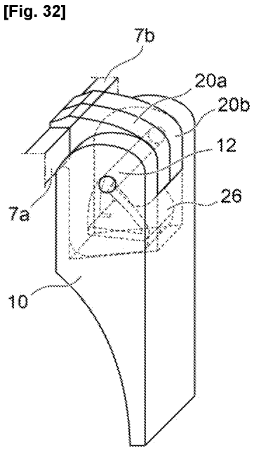

FIG. 31 is a perspective view of the second element of the system from FIG. 30.

FIG. 32 is a perspective view of the system from FIG. 30.

FIG. 33 is a view of the first element in a configuration allowing the disengagement of the first and second elements in case of excessive pulling on an eyewear temple.

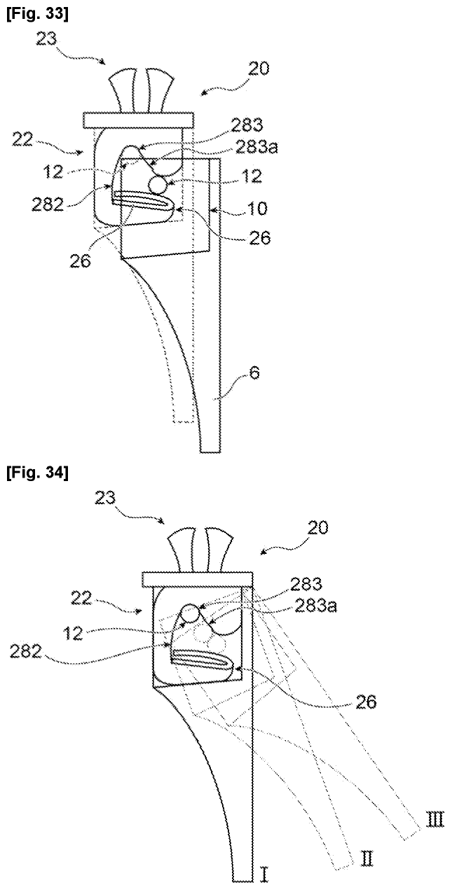

FIG. 34 is a view of the first element from FIG. 33.

FIG. 35 illustrates an embodiment of the hinge system according to the invention, in which the retaining element is integral with a lever allowing direct attachment to an eyewear temple or front part.

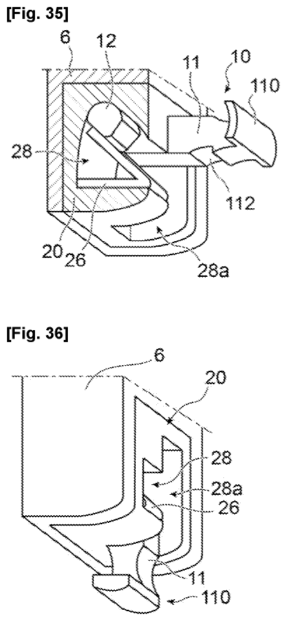

FIG. 36 illustrates in the hinge system from FIG. 35, with the two elements in an unfolded configuration.

FIG. 37 is a perspective view of the elastic return device according to another embodiment.

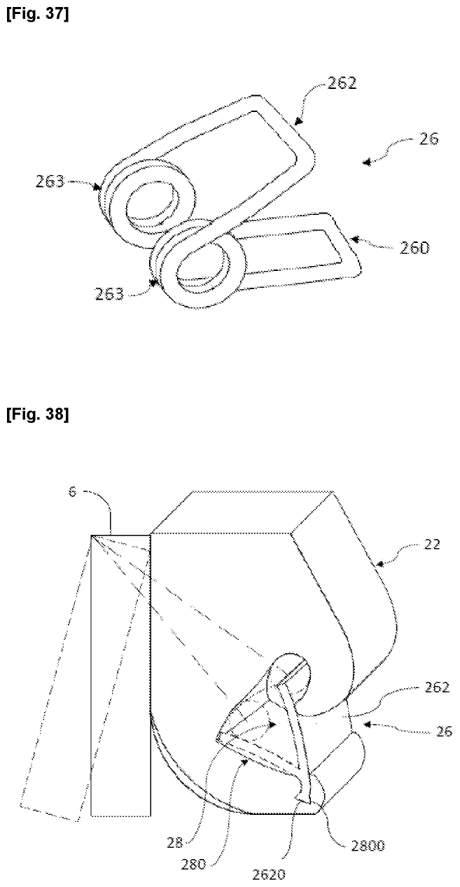

FIG. 38 is a perspective view of the second element equipped with the elastic return device according to a variant embodiment.

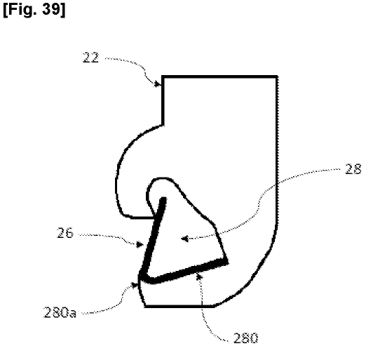

FIG. 39 schematically shows the elastic return device mounted in the second element.

FIG. 1 shows eyewear 2 equipped with hinge systems 1 according to the invention. The eyewear 2 in this example is corrective eyewear and conventionally includes a frame 3 and corrective lenses 4 secured to the frame 3. The frame 3 consists of a front part 5 and two temples 6, each articulated by means of a respective hinge system 1. The temples 6 can thus rotate relative to the front part 5, particularly between an unfolded position, visible in FIG. 1, allowing the user to wear the glasses, and a folded position, in which the temples are folded towards the front part 5, especially for storing the glasses.

A hinge system 1 according to the invention is shown in FIGS. 2 to 10. It includes a first element 10 and a second element 20 configured to be reversibly attached to each other. In the example of FIGS. 2 to 10, the first element 10 is intended to be carried by a temple 6 of the eyewear 2, while the second element 20 is intended to be carried by the front part 5. Alternatively, an inverse configuration can be provided, in which the first element 10 is carried by the front part 5, while the second element 20 is carried by a temple 6.

The first element 10 includes a retaining element 12 with a generally elongated shape along a longitudinal axis. This retaining element can be integral with the first element 10 or mounted removably on the first element. The longitudinal axis of the retaining element 12 is, in an operating configuration of the hinge system 1, parallel to the rotation axis of the first element 10 relative to the second element 20. In this example, the retaining element 12 takes the form of a rod. The second element 20 includes a hooking part 22, with the hooking part 22 featuring a part forming a hook 24 and a fixing part 23 allowing the second element 20 to be attached to an eyewear component, such as the front part 5 of the eyewear 1 or a temple. In the example, the fixing part 23 is intended to be overmolded within the front part 5, which is made at least partially of plastic material (such as acetate), but it can be fixed to an eyewear frame by any suitable means (riveting, gluing, screwing, etc.). In the example of FIGS. 2 to 8, the first element 10 is integral with a frame 100 (notably a metal frame), configured to form a temple 6 of the eyewear, or to be integrated into such a temple 6, for example by overmolding when the temple 6 includes a plastic material. Alternatively, the first element 10 can be directly attached to a temple 6 (or a front part 5) by any suitable means (riveting, screwing, gluing, etc.). Alternatively, as shown in FIGS. 9 and 10, the first element 10 can be at least partially formed directly within a temple of eyewear, with the temple then including a terminal part forming the entirety of the first element 10 except for the retaining element 12.

The hook 24 and the retaining element 12 are configured, in an engaged configuration visible in FIGS. 7, 8, and 10, to cooperate in a way that allows the rotation of the first element 10 relative to the second element 20, thereby enabling the rotation of a temple 6 relative to the front part 5. The rotation between the first element 10 and the second element 20 can occur between at least a folded position and an unfolded position. In the engaged configuration, the second element 20 is preferably partially embedded in the first element 10. In the example of the figures, the hooking part 22 of the second element 20 is at least partially enclosed by two side walls 14, or cheeks 14, of the first element 10. Each cheek 14 includes a cavity 140, which may or may not be through, configured to receive one end of the retaining element 12. The retaining element 12 can be fixedly attached to the first element 10 or simply inserted into the cavities 140 provided for this purpose. The retaining element 12 can be rotationally fixed relative to the first element 10 or free to rotate relative to the first element 10. The first element 10 can include a bottom wall 16 joining the two side walls 14.

To allow mutual and reversible fixation of the first and second elements 10, 20, the second element 20 includes an elastic return device 26 (visible particularly in FIG. 6), positioned within an open cavity 28. The cavity 28 is formed in the hooking part 22 so that the hook 24 delineates part of the cavity 28, and in particular, part of the cavity's opening. The cavity 28 is configured to allow the insertion of the retaining element 12 into the cavity 28, to a position where the retaining element 12 engages with the hook 24. To this end, the cavity 28 includes a support wall 280 forming a support for the elastic return device 26, positioned at least partially opposite a free end 240 of the hook 24. The cavity 28 is shaped so that the cavity opening, i.e., the space between the free end 240 of the hook 24 and the support wall 280, allows the passage of the retaining element 12, in a direction perpendicular to the longitudinal axis of the retaining element 12.

Advantageously, the cavity 28 contains the entirety of the elastic return device 26. Thus, the elastic return device 26 is not visible when mounted in the cavity 28, making the hinge system particularly aesthetically pleasing. Moreover, since the elastic return device 26 is fully housed within the cavity 28, its access is restricted, thereby protecting it from unintended mechanical stress that could dislodge it, making the hinge system particularly robust.

The elastic return device 26, an example of which is shown in FIG. 6, is an angular action spring 26, positioned in the hooking part 22 to resist the insertion of the retaining element 12, to deform to allow the passage of this element under sufficient force, and then to push the retaining element back towards a bottom 242 of the hook 24. The spring 26 includes, for this purpose, a first part 260 and a second part 262 integral with the first part 260. In the example of FIG. 6, the two parts 260, 262 are flat and form an angle between them, notably an angle between 30° and 90° when the spring is not under stress. This angle can alternatively range between 30° and 90°, or between 45° and 90°, or even between 30° and 70°.

In the example of FIG. 37, the spring 26 is a torsion spring, specifically a double torsion spring (a single torsion or triple torsion could also be considered). The first part 260 and the second part 262 are connected by coils 263. In the example of FIG. 37, the first part 260 and the second part 262 are formed of two interconnected branches, but these branches can also be separate. In one embodiment, the support wall 280 includes one or more grooves into which the branches of the first part 260 can be at least partially inserted. Such a configuration allows for strong lateral retention of the spring 26.

Thus, the spring 26 has a general ‘V’ shape. In the example of FIGS. 2 to 10, the spring 26 is a leaf spring. In the example of FIG. 37, the spring 26 is a torsion spring, also featuring a general ‘V’ shape. Advantageously, the first part 260 and the second part 262 are of identical length, which ensures that neither of these two parts is required to rest against the support wall 280, thereby facilitating the assembly of this component in the second element 20.

In FIG. 38, the spring 26 is a single-leaf spring, with only the second part 262 forming a flexible blade. The support wall 280 and the flexible blade 262 define a general ‘V’ shape. An end 2620 of the blade 262 is inserted into a groove 2800 formed in the wall 280. For its placement, the spring 26 is slid laterally into this groove 2800. When the hinge system is assembled, the side walls 14 of the first element 10 block any lateral movement of the spring 26 in the groove 2800. The base of the end 2620 is slightly wider than the rest of the blade, and for example, it may be trapezoidal, triangular, rectangular, or spherical in shape, with the groove 2800 having a complementary shape to that base. In another embodiment, the blade 262 has a trapezoidal longitudinal section, preferably a rectangular trapezoidal shape, with the right angle located at the base of the end 2620 and oriented towards the outside of the cavity 28, with the groove 2800 having a complementary shape. This trapezoidal shape of the blade 262 favors its curvature (or flexion) when under stress. This mechanical connection between the spring 26 and the wall 280 ensures that the blade 262 remains secured in the groove 2800 when the blade is under stress. This connection can be likened to a dovetail joint, ensuring optimal retention of the spring 26 in the cavity 28.

Regardless of the spring 26's embodiment, the support wall 280 and the second part 262 of said spring define a general ‘V’ shape. It should be noted that the use of an angular action spring, particularly one with a ‘V’ shape or a single-leaf spring as shown in FIG. 38, and more generally, a spring whose second part 262 and the support wall 280 together define a general ‘V’ shape, ensures a simple and precise assembly of the spring in the second element 20. Indeed, as it is necessary to reduce the spring 26's volume by temporarily compressing it to insert it into the cavity 28, the spring 26, upon expanding inside the cavity and resting against the support wall 280 and the hook 24, will spontaneously adopt the required position, as depicted in FIG. 4.

The cooperation between the different elements of the hinge system 1, as well as the operation of the elastic return device 26, is more clearly visible in FIGS. 11 to 15, which illustrate the necessary steps to achieve the mutual engagement of the first and second elements 10, 20. The first step involves bringing the first element 10 (in this example, a temple 6 of the eyewear incorporating this element) close to the second element 20 (which is integral with a corresponding front part 5 of the eyewear). The position of the first element 10 should correspond to a folded position of the corresponding temple 6, or be close to such a position (FIG. 11). Next, the retaining element 12, or axle 12, is inserted between the hook 24 and the elastic return device 26, or spring 26 (FIG. 12). Then, pressure is applied to the elastic return device 26 by means of the retaining element 12 (thus through the first element 10 and the temple 6), forcing the retaining element 12 into the cavity 28 (FIG. 13, FIG. 14). Once the axle 12 has passed the free end 240 of the hook 24, the spring 26 can be released, with its action pushing the axle 12 towards the bottom 242 of the hook (FIG. 15). In the engaged configuration of the first and second elements 10, 20, the axle 12 is urged by the spring 26 towards the bottom 242 of the hook. The axle 12 is thus engaged with the hook 24. The action of the elastic return device 26, which tends to push the axle 12 towards the bottom of the hook 242, prevents any spontaneous disengagement of the axle 12 from the hook 24, and thus prevents the unintended separation of the first and second elements 10, 20.

If it is desired to disengage the first and second elements 10, 20, it is sufficient to perform the steps in reverse as described above, namely, moving the axle 12, through the first element 10 in the folded position (thus the temple 6 in the folded position, in this example) to push back the spring 26, and then pulling on the first element 10 until the axle 12 is freed from the hook 24, and thus from the second element 20.

It is therefore understood that the engagement and disengagement of the first and second elements 10, 20 can be done very simply and quickly, without requiring any tools. The simplicity of these operations makes them accessible to the eyewear wearer (including ‘blindfolded’, without their glasses), unlike the hinges of the prior art, which require specific tools for assembly and disassembly and are preferably performed by a professional.

Advantageously, the side walls 14 of the first element 10 enclose the second element 20, so that the play between the first element 10 and the second element 20 is very minimal or even nonexistent. This configuration contributes to the mutual retention of the two elements 10, 20 and the mechanical stability of the hinge system, especially during the phases of mutual rotation of the two elements 10, 20. Thus, the temples 6 attached to a front part 5 of the eyewear by means of hinge systems 1 according to the invention are fixed without axial play (i.e., without play in a direction parallel to the rotation axis). Moreover, when the hinge system is assembled, the elastic return device 26 is confined within the cavity 28, which is laterally enclosed (or ‘framed’) by the side walls 14 of the first element 10. The elastic return device 26 is therefore difficult to dislodge accidentally.

Advantageously, as shown particularly in FIGS. 16 to 19, the hinge system 1 according to the invention can be configured, very simply and without additional cost, to allow an extension of the eyewear temples, i.e., an extension beyond the unfolded position of the temples 6. This extension is accompanied by an elastic return of the temple, meaning that in case of extension beyond the unfolded position, the temple is elastically urged back to its unfolded position. This feature is achieved very simply thanks to the configuration of the cavity 28 and the elasticity of the spring 26, which allows the temple 6, integral with the first element 10 (and thus the axle 12), to rotate beyond the unfolded position, as shown in FIG. 16. FIG. 16 shows the unfolded position of a temple 6, which corresponds in this example to an angle of approximately 90° between a longitudinal axis X of the temple 6 and a longitudinal axis Y of the front part 5. In this position, the axle 12 is held in the bottom 242 of the hook (or in the immediate vicinity of this bottom 242, with slight detachment of the axle 12 being possible). If the temple 6 is moved away from this unfolded position (towards the outside), as shown in FIGS. 17 to 19, which show angles between the axes X and Y of 95°, 100°, and 105°, respectively, the axle 12 will push the spring 26 until it reaches its maximum compression in the fully extended position shown in FIG. 19. At the same time, the axle 12 moves along a bottom wall 282 of the cavity 28, a wall connecting the bottom 242 of the hook 24 to the support wall 280. Thus, a so-called ‘flex’ hinge system is achieved, allowing for a simple extension of up to 15° beyond the unfolded position. It should be noted that the hinge system 1 according to the invention allows for the creation of an extension hinge, known as a ‘flex’ hinge, in a simple manner and without additional cost compared to a version that does not permit such an extension. A similar operation occurs with the single-leaf spring 26 shown in FIG. 38.

Preferably, the bottom wall 282 features a convex portion 282a that, during the extension movement beyond the unfolded position, maintains the distance between the retaining element 12 and the part of the front facing the rotation point of the temple 6, located at an outer edge 60 of the temple 6, constant. This distance corresponds to radius R2, visible in FIGS. 17 and 19 (and also in FIGS. 20 and 22). Advantageously, the surface of the convex portion 282a forms a cylindrical section with a diameter R2, as particularly visible in FIGS. 20 and 22. This prevents the temple 6 from protruding from the front part 5 during the extension movement, thereby preserving the aesthetic continuity between the temple 6 and the front part 5, regardless of the position of the temple 6. This convex portion 282a also ensures smooth rotation, without jerks, for both rotational movements towards a ‘folded/unfolded’ position of the temple 6, as well as in ‘flex’ rotation.

Advantageously, as visible in FIGS. 16 to 19, the axle 12 includes at least one flat surface 120. Such a configuration allows for a reduction in the bulk of the retaining element 12 and thus of the hinge system 1. Indeed, since the spring 26 rests on the flat surface 120, the spring 26 is closer to the longitudinal axis of the retaining element 12 than when it rests on a retaining element without a flat surface. This configuration thus reduces the bulk of the second element in the direction of the temples in the unfolded position (i.e., the bulk along the X direction as shown in FIG. 16), and, more generally, reduces the bulk of the hinge system 1. In this case, it is necessary that the retaining element 12 is not rotationally fixed to the first element 10, so that the flat surface 120 and the second part 262 of the spring 26 are always aligned, regardless of the relative position of the first and second elements 10, 20.

Alternatively, a retaining element 12 with at least one flat surface 120 can provide indexing of at least one position (for example, the unfolded position) through cooperation between the flat surface 120 and the spring 26. Such a configuration requires the axle 12 to be rotationally fixed to the first element 10. Thus, during the rotation of the temple 6 from the folded position to the unfolded position, the action of the spring 26 on the axle 12 will tend, due to the flat contact between the spring 26 and the axle 12, to maintain the orientation of the axle 12 (and thus of the first element 10) when it corresponds to the unfolded position of the temple 6 integral with the first element 10.

Advantageously, as particularly visible in FIG. 20, the hooking part 22 includes a rear part 200, located at the rear of the cavity 28. The rear part 200 may include a circular portion with a radius R and a center C (the center C coinciding with the position of the longitudinal axis of the shaft 12 when the two elements 10, 20 are in an engaged configuration). The radius R is then less than or equal to the distance D between the center C and the bottom wall 16 of the first element 10 (which in the example is formed by a part of the temple 6, specifically by a part of the frame 100).

Advantageously, the radius R is close to or equal to the distance D. Specifically, the value of the distance D is close enough to the value of the radius R to ensure contact between the rear part 200 and the bottom 16 during the rotation of the temple 6.

Advantageously, as shown in FIG. 20, the rear part 200 includes a protrusion 202 relative to the circular shape with radius R. In this example, the protrusion has a gradual profile, reaching a maximum for a rotation angle of the first element between 30° and 60° (relative to the unfolded position), and, for example, equal to or close to 45°. The protrusion 202 creates a resistance point during the rotation of the temple 6 (in both directions of rotation). Thus, passing this resistance point, which is accompanied by additional compression of the spring 26, provides an automatic return of the corresponding temple to the unfolded or folded position, depending on the direction of rotation. At its maximum, the protrusion results in an excess thickness e relative to the radius R, which is less than 2 millimeters, or less than 1 millimeter, and, for example, less than 0.5 millimeters. In this case, the distance D mentioned above is between R and R+e.

Advantageously, as shown in FIG. 21, which illustrates three different embodiments of the retaining element 12, the latter may include a central part 121 with a smaller cross-sectional area than the end sections 122. In this case, the ends 122 are shaped to allow the rotation of the shaft 12 relative to the first element 10. For example, the cross-sectional shape of the ends 122 is circular. Such a configuration limits the movements of the shaft 12 by the spring 26 when it is in contact with the shaft 12, specifically with the central part 121. Indeed, on the one hand, the cooperation between the shape of the central part 121 and the spring 26 limits the movements of the shaft 12 (in its longitudinal direction), and on the other hand, the movements of the spring 26 within the cavity 28 are limited by the first element 10, whose side walls 14 enclose, or even clamp, the second element 20 in which the spring 26 is inserted. Such a configuration allows for a simplified hinge system assembly without fixing the retaining element 12. Indeed, when at least one of the cavities 140 formed in the side walls 14 of the first element 10 is through-going, it is possible to position the retaining element 12 by directly inserting it into the corresponding cavity 140 (or through one of the cavities 140 when both are through-going). Once the first and second elements 10, 20 are in the engaged configuration, the spring 26 is supported on the central part 121 of the retaining element 12 as explained above, which prevents the retaining element 12 from spontaneously ejecting from the hinge system. As shown in FIG. 21, the central part 121 with a reduced cross-section can be achieved in various ways, for example, using a flat 120, a symmetric revolved shape with a diameter smaller than the diameter of the ends 122, or a shape featuring multiple flats 120 distributed along the periphery of the central part 121. The retaining elements 12 in FIG. 21 can advantageously be used in the configuration shown in FIGS. 16 to 19.

FIG. 22 shows a configuration similar to that of FIG. 20, with the temple 6 in an extended position as defined above. In FIG. 22, an arc with radius R2 is depicted, coinciding with the convex portion 282a of the bottom wall 282. The radius R3, corresponding approximately to the movement of the free end of the upper part of the spring 26 when it is pushed by the retaining element 12 during the extension movement, is also depicted. As visible in FIG. 22, radii R2 and R3 may be tangent at one point, but should not be secant for the proper functioning of the hinge system 1. The configuration of the convex portion 282a in FIG. 22 is preferably implemented for all the embodiments described in this application where the possibility of an extension movement is desired.

Advantageously, as seen in FIGS. 23 to 26, the shaft 12 may feature two flats 120, each flat allowing for the indexing of either the unfolded position (FIG. 24) or the folded position (FIG. 23). The angle between the flats 120 corresponds to the angle between the unfolded and folded positions of the temple 6. As seen in FIGS. 25 and 26, the ends 122 of the shaft 12, which are designed to be inserted into the cheeks 14 of the first element 10, have a cylindrical shape with either a circular (FIG. 26) or non-circular (FIG. 25) cross-section. In the example of FIG. 25, the ends 122 of the shaft 12 have a non-symmetric revolved shape, specifically an oblong cross-sectional shape. Such a shape allows for rotation locking when the shaft 12 is inserted into the cavities 140 of the first element 10 (which then have a complementary shape), and also acts as a guide when the shaft 12 must be inserted in a specific angular position (which will generally be the case if one wishes to achieve indexing of one or both of the folded and unfolded positions).

The presence of two flats 120, as shown in FIGS. 23 to 26, also provides a resistance point similar to that described earlier when moving from the unfolded to the folded position and vice versa. Indeed, during the rotation of the first element 10, for example, when moving from the unfolded position (FIG. 23) to the folded position (FIG. 24), the rotation of the retaining element 12 relative to the second element 20 will cause the latter to roll over the spring 26. The spring 26, initially pressed against one of the flats 120 (FIG. 23), will, after the rotation movement, be pressed against the other flat 120 (FIG. 24). During the transition phase between the spring 26 being pressed against one flat and the other flat 120, the retaining element 12 is in contact with the spring 26 via the edge (or rounded edge, as the case may be) formed between the two flats 120. During this transition phase, element 12 pushes the spring 26. This additional effort exerted by the retaining element 12 during the transition phase results in increased resistance to the rotation movement. This additional resistance is felt by the user as a resistance point. Once the edge formed between the two flats is passed, the resistance to the rotation movement decreases, and the action exerted by the spring 26 on the retaining element 12 tends to urge the first element towards its final position, that is, towards the unfolded or folded position, depending on the direction of rotation.

Advantageously, as visible in FIGS. 16 to 19 and 23 and 24, the rear part of the second element includes a recess 206 to facilitate the movement of the first element 10, particularly during the extension movement beyond the unfolded position of the temple 6. The recess 206 prevents any contact between the outer edge 60 of the temple 6 and the rear of the front part 5 during the extension movement. Indeed, the recess ensures that the inner edge 62 of the corresponding temple is guided, allowing, in combination with the convex portion 282a of the bottom wall 282, to ensure that during the extension movement, the outer edge 60 of the temple slightly moves away from the frame front. Moreover, the guiding of the inner edge 62 of the corresponding temple is designed so that during the extension movement, no lateral shift of the temple 6 occurs (meaning that the position of the outer edge 60 along a direction parallel to the Y-axis of FIG. 16 does not change during the extension movement).

Advantageously, the inner edge 62 of the eyewear temple includes a protruding portion (formed on the temple and/or the first element) that enhances the cooperation between the inner edge 62 and the recess 206 of the second element. This avoids any friction between the temple and the front part that could damage either the front part or the temple.

Advantageously, the support wall 280 has a free-end lip 280a that helps position and limit the possible movements of the spring 26 during the manipulation of the hinge system 1. The lip 280a particularly helps keep the spring 26 in place and prevents unintentional extraction of the spring 26 from its housing in the second element during operations aimed at disengaging the first and second elements from each other. In FIG. 39, the lip 280a has a curvature forming a hook, against which the spring 26 is supported.

Advantageously, as seen in FIGS. 27 and 28, the support wall 280 includes a groove 280b into which one of the parts 260, 262 of the spring 26 can be at least partially inserted. This configuration provides strong lateral retention of the spring 26 (noting that when the two elements 10, 20 are assembled, the spring 26 is, in any case, prevented from exiting by the cheeks 14 of the first element). A groove 282b can also be made in the bottom wall 282 of the cavity, with the free end of part 262 of the spring 26 in contact with the shaft 12 being able to move within the groove 282b during the compression and relaxation movements of the spring 26. This configuration ensures that the contact surface between the shaft 12 and the spring 26 is maximized (including during the extension movement), as it allows maximizing the length of part 262 of the spring that is supported by the shaft 12. Compared to the configuration shown in FIGS. 20 and 22, the configuration in FIGS. 27 and 28 corresponds to a setup where radii R2 and R3 are secant.

As visible in FIG. 29, the spring 26 can be a spring with parts 260, 262 having a circular cross-section (for example, a wire spring), in which case it is preferable to provide a groove 280b in the support wall 280 and a groove 282b in the bottom wall 282 to ensure satisfactory lateral retention of the spring 26.

FIGS. 30 to 32 show an embodiment of the hinge system 1 adapted to so-called rimmed eyewear. As seen in FIG. 30, each lens 4 is surrounded by a rim 7 (partially shown), particularly a metal rim. The second element 20, better visible in FIG. 31, is attached to the rim 7 and, for this purpose, includes two half-parts 20a, 20b that are attached to each other but can be separated from each other in an open configuration of the rim 7, allowing for the mounting or dismounting of the lenses 4. For this purpose, the rim 7 includes two end parts 7a, 7b that can be separated, and each half-part 20a, 20b of the second element 20 is attached respectively to one of the end parts 7a, 7b of the rim 7, for example, by welding. The two half-parts 20a, 20b are kept together when the first and second elements 10, 20 are in an engaged configuration, with the cheeks 14 of the first element enclosing the half-parts 20a, 20b of the second element 20. In the engaged configuration, the retention of the two half-parts 20a, 20b together ensures the rim 7 is held in a closed configuration. The arrangement in FIGS. 30 to 32 eliminates the need for four screws compared to known frames—two screws for attaching the lens rims and two hinge screws. Advantageously, one of the two half-parts includes a section forming a cover 20c, which conceals the junction between the two half-parts. Advantageously, the second element 20 includes an indexing element 280c, in the form of a protrusion 280c integral with one of the half-parts 20a. The protrusion 280c ensures the correct positioning and lateral retention of the spring 26, with the spring 26 featuring a complementary-shaped notch 264. Advantageously, the half-part 20b that does not include the protrusion 280c has a chamfered lateral edge that forms part of the contour of the cavity 28. This configuration is designed to facilitate the insertion of the spring 26 when it is pre-positioned in the half-part 20a with the protrusion 280c during the assembly of the two half-parts 20a, 20b.

FIGS. 2 to 29 show examples of the hinge system according to the invention in which the second element 20 includes a hooking part 22 with a cavity 28 intended to be oriented inward when the hinge system 1 is used on eyewear. In other words, when the temples are unfolded, the cavities 28 of the second elements 20 of each temple 6 are oriented inward, facing each other. FIGS. 30 to 32, 33, and 34 illustrate an example in which the first element 10 is configured so that the cavity 28 is oriented outward. The operation of the second element 20 and its cooperation with the first element 10 are similar to those described earlier. However, during the extension movement of the temple 6 (i.e., the movement beyond the unfolded position), the retaining element 12, due to the reversed configuration of the second element 20, will move along an opposite wall 283 to the bottom wall 282 (instead of along the bottom wall 282, as in the previously described embodiments). This configuration ensures better security for the attachment of the temples 6 to an eyewear frame, allowing an excessive extension of a temple to result in the separation of the temple from the frame. FIG. 34 shows three different positions of an eyewear temple: the unfolded position (Position I), the maximum extension position (Position II), and an extraction position (Position III). Thus, as shown in Position III, excessive extension of the temple will lead to the extraction of the shaft 12 from the cavity 28, thereby separating the temple from the frame and preventing damage to the frame. Advantageously, the opposite wall 283 features a concave part 283a, allowing for the indexing of the maximum extension position before the separation of the first and second elements (Position II).

FIGS. 35 and 36 illustrate an embodiment in which the second element 20 is integral with an eyewear temple 6, while the first element 10 is intended to be attached to an eyewear frame 5. In the example of FIGS. 35 and 36, the first element includes a lever 11, one end of which is integral with the retaining element 12. The lever 11 has a fixing part 110 at the end opposite the retaining element 12, which is configured to be attached to an eyewear frame, for example, by overmolding. The second element forms a housing configured to receive the spring 26 and the retaining element in a configuration similar to the various configurations described above. Thus, the second element includes a cavity 28 that accommodates the spring 26 and the retaining element 12. The second element also includes a housing 28a that communicates with the cavity 28, allowing part of the lever 11 to be received and permitting its rotation, as shown in FIGS. 35 and 36, which depict two angular positions of the first element 10 and therefore of the lever 11. Advantageously, the lever 11 features a recess 112 positioned between the retaining element 12 and the fixing part 110. The recess 112 enables an extension movement as described above, meaning a movement beyond the unfolded position, as shown in FIG. 36.

Of course, as with all the embodiments described above, the first element 10 in FIGS. 35 and 36 can be configured to be integral with an eyewear temple 6, while the second element 20 can be configured to be integral with an eyewear frame 5. Such a reversed configuration compared to the embodiment in FIGS. 35 and 36 is particularly suitable for metallic eyewear, particularly so-called drilled or nylor eyewear.

1. Hinge system (1) for eyewear (2), the hinge system (1) comprising:
a first element (10) comprising a retaining element (12);
a second element (20) comprising a hooking part (22) forming a hook (24), the hook (24) being configured to reversibly engage the retaining element (12) of the first element (10), the hook (24) and the retaining element (12) being configured to allow, in an engaged configuration of the first element (10) and the second element (20), the rotation of the first element (10) relative to the second element (20) between at least a first position, or folded position, and at least a second position, or unfolded position, the second element (20) comprising an elastic return device (26), which is an angular action spring configured to:
when the first and second elements (10, 20) are in an engaged configuration, urge the retaining element (12) toward a position where the retaining element (12) is held by the hook (24), so that the action of the elastic return device (26) opposes the release of the retaining element (12) by the hook (24); and to
elastically deform to allow the engagement or disengagement of the retaining element (12) and the hook (24) when a force is applied to the elastic return device (26) through the first element (10) with sufficient intensity,
and wherein the second element (20) includes an open cavity (28) formed in the hooking part (22) so that the hook (24) defines part of the cavity (28), the cavity (28) being configured to allow the insertion of the retaining element (12), characterized in that:
the elastic return device (26) is positioned within the cavity (28), which cavity includes a support wall (280) that serves as a support for the elastic return device (26),
the elastic spring device (26) has a part (262) that urges the retaining element (12) in the engaged configuration, with the support wall (280) and said part (262) forming a general ‘V’ shape.

2. Hinge system (1) according to the previous claim, wherein the elastic return device (26) is further configured to elastically deform to allow the displacement of the retaining element (12) relative to the hook (24) when the first element (10) is rotated from the unfolded position, in the same direction as the transition from the folded position to the unfolded position, the cavity (28) being configured so that the displacement of the retaining element (12) allows for exceeding the unfolded position, the first element (10) being returned to the unfolded position by the action of the elastic return device (26) when it is no longer solicited.

3. Hinge system (1) according to one of claims 1 and 2, wherein the cavity (28) contains the entirety of the elastic return device (26), which cavity (28) is laterally sealed by the side walls (14) of the first element (10).

4. Hinge system (1) according to one of the preceding claims, wherein the elastic return device (26) comprises at least one leaf spring or a torsion spring.

5. Hinge system (1) according to one of claims 1 to 4, wherein the elastic return device (26) has a general ‘V’ shape, the elastic return device comprising a first part (260) and a second part (262), the two parts forming an angle between them when the elastic return device (26) is not engaged, preferably an angle of less than 90°.

6. Hinge system (1) according to the preceding claim, wherein the first part (260) and the second part (262) have the same length.

7. Hinge system (1) according to one of claims 1 to 3, wherein:
the elastic return device (26) is a single-leaf spring with a flexible blade (262), one end (2620) of said blade (262) being inserted into a groove (2800) formed the support wall (280), in
the base of the blade end (2620) is wider than the rest of said blade, the groove (2800) having a shape complementary to said base, like a dovetail joint,
the support wall (280) and the flexible blade (262) define a general ‘V’ shape.

8. Hinge system (1) according to one of the preceding claims, wherein a free edge of the support wall (280) facing the hook (24) includes a rim (280a) allowing the positioning and retention of the elastic return device (26).

9. Hinge system (1) according to one of the preceding claims, wherein the retaining element (12) is integral with the first element (10) or removably mounted on the first element (10).

10. Hinge system (1) according to the preceding claim, wherein the retaining element (12) has a straight cylindrical shape, particularly with a circular base.

11. Hinge system (1) according to one of the preceding claims, wherein the first element (10) includes two side walls (14) shaped to partially enclose the second element (20), each side wall (14) having a cavity (140) configured to receive an end (122) of the retaining element (12).

12. Hinge system (1) according to the preceding claim, wherein the side walls (14) are configured to enclose the second element (20) in the engaged configuration.

13. Hinge system (1) according to one of claims 11 and 12, wherein the retaining element (12) includes at least a central part (121) with a smaller cross-sectional area than the ends (122), the central part (121) forming a bearing surface for the elastic return device (26), the retaining element (12) being rotatably mounted within the first element (10).

14. Hinge system (1) according to the preceding claim, wherein the central part (121) of the retaining element (12) includes at least one flat surface (120).

15. Hinge system (1) according to one of claims 1 to 12, wherein the retaining element (12) includes at least one flat surface (120) forming a bearing surface for the elastic return device (26), the retaining element (12) being rotationally integral with the first element (10), the cooperation between the flat surface (120) and the elastic return device (26) allowing for indexing the first element (10) in a specific angular position relative to the second element (20).

16. Hinge system (1) according to the preceding claim, wherein the retaining element (12) comprises two flat surfaces (120) with different orientations, to obtain two distinct indexed positions, corresponding for example to the unfolded and folded positions, respectively.

17. Hinge system (1) according to one of the preceding claims, wherein the second element comprises two half-parts (20a, 20b) assembled along a plane perpendicular to the axis of rotation of the first element (10).

18. Hinge system (1) according to the preceding claim, wherein the second element (20) comprises an indexing element (280c) for the position of the elastic return device (26), for example, a protruding element (280c) cooperating with a notch (264) formed in the elastic return device (26).

19. Hinge system (1) according to one of claims 1 to 8, wherein the first element (10) includes a lever (11), one end of which is integral with the retaining element (12), the lever (11) including, at an end opposite the retaining element (12), a fixing part (110), the second element (20) having a housing (28a) communicating with the cavity (28), the housing (28a) being configured to receive part of the lever (11) and allow its rotation when the first and second elements (10, 20) are in the engaged configuration.

20. Glasses (2) comprising two temples (6) connected to a front frame (5), each temple (6) being articulated by means of a hinge system (1) according to one of the preceding claims, the unfolded and folded positions of each hinge system (1) corresponding respectively to the unfolded and folded positions of the respective temple (6).

21. Eyewear (2) according to the preceding claim, wherein each hinge system (1) is configured to allow an extension movement, i.e., a rotational movement of the corresponding temple (6) in the same direction as the rotation that allows the transition from the folded position to the unfolded position, bringing the temple (6) beyond the unfolded position, the extension movement generating an elastic deformation of the elastic return device (26) under the action of the retaining element (12).

22. Eyewear (2) according to the preceding claim, comprising a hinge system according to claim 9, wherein the retaining element (12) moves, during the extension movement of the corresponding temple (6), along a bottom wall (282) of the cavity (28), the bottom wall (282) preferably featuring a convex portion (282a).

23. Glasses (2) according to the preceding claim, wherein the second element (20) comprises a rear part (200) comprising a recess (206) configured to guide an inner edge (62) of the corresponding temple (6) during the extension movement.

24. Glasses (2) according to the preceding claim, wherein the first element (10) and/or the corresponding temple (6) comprises an inner edge (62) with a protruding portion cooperating with the recess (206) of the second element (20) during the extension movement.

25. Glasses (2) according to one of claims 20 to 24, wherein, for each temple (6), the first element (10) of the corresponding hinge system is integral with the front frame (5), and the second element (20) is integral with the temple (6).

26. Glasses (2) according to one of claims 20 to 24, wherein, for each temple (6), the second element (20) of the corresponding hinge system (1) is integral with the temple (6), and the first element (10) is integral with the front frame (5).

27. Glasses (2) according to one of claims 20 to 26, wherein, for each temple (6), the second element (20) is configured such that the hook (24) is located on the inner side of the temple (6).

28. Eyewear (2) according to one of claims 20 to 26, wherein, for each temple (6), the second element (20) is configured so that the hook (24) is positioned on the outer side of the temple (6).
